(19) United States
(12) Patent Application Publication
(10) Pub. No.: US 2023/0155708 A1
(43) Pub. Date: May 18, 2023

(54) PROVIDING EMERGENCY ALERTS TO CONNECTED RADIO RECEIVERS

(71) Applicant: Ibiquity Digital Corporation, Columbia, MD (US)

(72) Inventors: Marek Milbar, Huntingdon Valley, PA (US); Paul Venezia, Keene, NH (US)

(21) Appl. No.: 17/995,515

(22) PCT Filed: Apr. 6, 2020
(86) PCT No.: PCT/US2020/026831

§ 371 Date: Oct. 5, 2022

(51) Int. Cl. H04H 60/87; H04H 20/59; H04H 60/78

(52) U.S. Cl. CPC H04H 60/87; H04H 20/59; H04H 60/78

(57) ABSTRACT

An audio delivery system (100) can include an alert processor (108) configured to parse alert content. The alert processor can receive first data representing the alert content. The alert processor can convert the alert content to an alert message that includes alert text and parameters. A connected radio server (120), coupled to the alert processor via internet protocol, can insert the alert content into a data stream. The connected radio server can receive second data representing the alert message from the alert processor via internet protocol. The connected radio server can receive instructions from the alert processor via internet protocol to incorporate the alert message into the data stream. The data stream can include an audio stream and the alert message. The connected radio server can provide the data stream to a connected radio receiver (102) via internet protocol.

### FIELD OF THE DISCLOSURE

The present disclosure relates to providing emergency alerts to radio receivers.

### BACKGROUND OF THE DISCLOSURE

As broadcast radio technology evolves, the technology for providing emergency alerts evolves as well.

### SUMMARY

In a first example, an audio delivery system can include: an alert processor configured to parse alert content by: receiving first data representing the alert content; and converting the alert content to an alert message that includes alert text and parameters; and a connected radio server coupled to the alert processor via internet protocol and configured to insert the alert content into a data stream by: receiving second data representing the alert message from the alert processor via internet protocol; receiving instructions from the alert processor via internet protocol to incorporate the alert message into the data stream, the data stream including an audio stream and the alert message; and providing the data stream to a connected radio receiver via internet protocol.

In a second example, a method for operating an audio delivery system can include: receiving, with an alert processor, first data representing alert content; converting, with the alert processor, the alert content to an alert message that includes alert text and parameters; receiving, with a connected radio server coupled to the alert processor via internet protocol, second data representing the alert message from the alert processor via internet protocol; receiving, with the connected radio server, instructions from the alert processor via internet protocol to incorporate the alert message into the data stream, the data stream including an audio stream and the alert message; and providing, with the connected radio server, the data stream to a connected radio receiver via internet protocol.

In a third example, an audio delivery system can include: an alert processor configured to parse alert content by: receiving first data representing the alert content; and converting the alert content to an alert message that includes alert text and parameters; and a connected radio server coupled to the alert processor via internet protocol and configured to insert the alert content into a data stream by: receiving, via a secure variant of transmission control protocol (TCP), second data representing the alert message from the alert processor via internet protocol; receiving instructions from the alert processor via internet protocol to incorporate the alert message into the data stream, the data stream including an audio stream and the alert message; and providing the data stream to a connected radio receiver via internet protocol; an exporter configured to receive, from the alert processor, via user datagram protocol (UDP), third data representing the alert message; and a transmitter coupled to the exporter and configured to broadcast over-the-air an over-the-air audio stream that incorporates the alert message.

### BRIEF DESCRIPTION OF THE DRAWINGS

FIG. 1 shows an example of an emergency alert broadcast distribution system for connected (e.g., streaming) services broadcast receivers, in accordance with some examples.

FIG. 2 shows an example of an emergency alert handling process for an alert processor, in accordance with some examples.

FIG. 3 shows an example of an emergency alert handling process for a connected radio server, in accordance with some examples.

FIG. 4 shows an example of an emergency alert handling process 400 for an HD radio/analog/connected (e.g., streaming) receiver, in accordance with some examples.

FIG. 5 shows an example of how the HD radio/analog'connected (e.g., streaming) receiver processes a received signal, in accordance with some examples.

FIG, 6 shows a flowchart of an example of a method for operating an emergency alert broadcast distribution system for connected (e.g., streaming) services broadcast receivers, in accordance with some examples.

FIG. 7 shows a flowchart of another example of a method for operating an emergency alert broadcast distribution system for connected (e.g., streaming) services broadcast receivers, in accordance with some examples.

FIG. 8 shows an example of a message depository container for use with a common altering protocol (CAP), in accordance with some examples.

FIG. 9 shows an example of fields found in each resource group of FIG. 8, in accordance with some examples.

FIG. 10 shows an example of fields found in each area group of FIG. 8, in accordance with some examples.

FIG. 11 shows an example of fields found in each info group of FIG. 8, in accordance with some examples.

FIG. 12 shows an example of fields found in the alert group of FIG. 8, in accordance with some examples.

FIG. 13 shows an example of a payload structure for a processed message, in accordance with some examples.

FIG. 14 shows an example of an emergency alert message distributed over a station information service (SIS) dedicated channel, in accordance with some examples.

FIG. 15 shows an example of an alert message encapsulation for internet protocol (IP) communication, in accordance with some examples.

Corresponding reference characters indicate corresponding parts throughout the several views. Elements in the drawings are not necessarily drawn to scale. The configurations shown in the drawings are merely examples, and should not be construed as limiting the scope of the invention in any manner.

### DETAILED DESCRIPTION

Historically, analog broadcast systems have incorporated technology to inform listeners in the event of an emergency. From 1963 to 1997, radio broadcasters in the United States used a system known as the Emergency Broadcast System. In the event of a national emergency, the Emergency Broadcast System would activate and would override the programming of a broadcaster to deliver information regarding the emergency. Since 1997, radio broadcasters in the United States have used an upgraded system known as the Emergency Alert System (EAS). The Emergency Alert System can also address a national emergency, but added a capability to alert listeners in a particular geographic region to severe weather, child abductions, and other civic emergencies. This added locality is beneficial, and is maintained with added granularity in the alert system discussed herein.

HD radio is an in-band on-channel digital radio technology currently used by AM and FM radio stations in the United States, Canada, and Mexico to transmit audio and data by embedding a digital signal at one or more frequencies adjacent to a station's standard analog signal. HD radio is compatible with use of the existing Emergency Alert System.

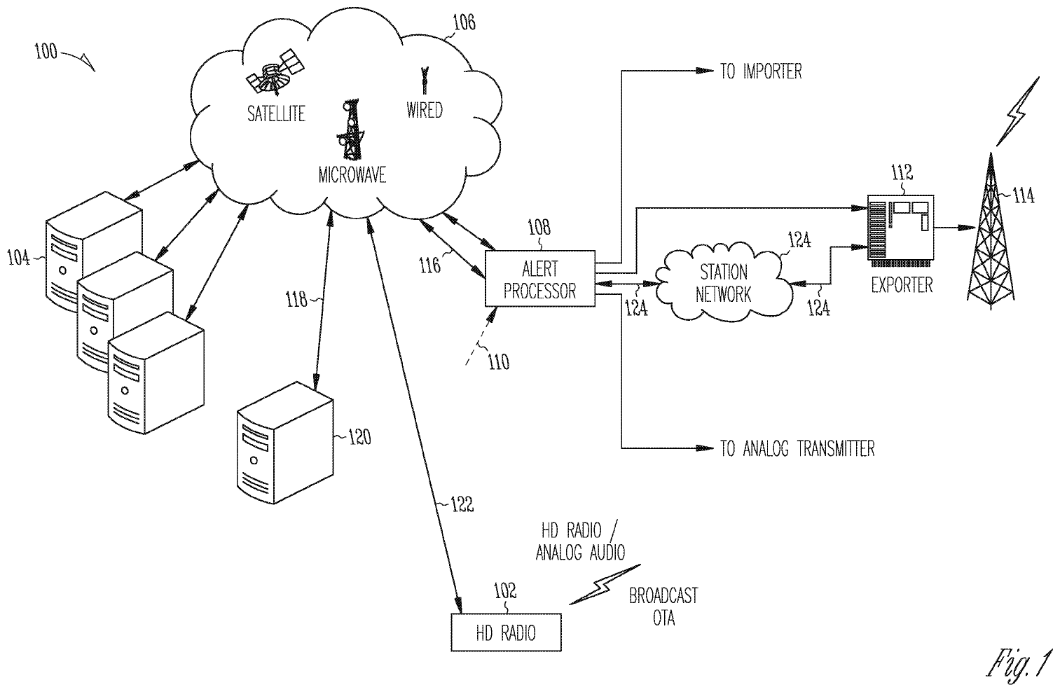

FIG. 1 shows an example of an emergency alert broadcast distribution system 100 for connected (e.g., streaming) services broadcast receivers 102, in accordance with some examples. The system 100 of FIG. 1 is but one example of an emergency alert broadcast distribution system; other suitable systems can also be used.

In some examples, any authorized person in the U.S., such as a representative of the Federal Emergency Management Agency or another federal, state or county emergency management entity, can issue an alert message. The alert message can include text and/or audio components. The originator of the alert message can use web-based tools to generate the message. The alert system can store the message in an authorized depository server 104 at a federal level (most likely) or at a state level or a county level. In some examples, a single depository server can be used. In other examples, the alert system can include an optional aggregation server, linked to the depository server. The aggregation server can contain alert messages from other originators that can be intended for various locations across the U.S.

In some examples, the depository server 104 can include one or more stand-alone computers disposed at a radio station, or at a remote location and linked to the radio station via a wired and/or wireless connection. In some examples, the depository server 104 can alternatively be a virtual machine that runs in the cloud, with an execution on a remote server that is disposed away from the radio station and connected to the radio station via a wired and/or wireless connection. In this respect, the depository server 104 can exist in hardware, software, or a combination of hardware and software.

The depository server 104 can communicate with other components of the system 100 via a distribution network 106. The distribution network 106 can include wired communication, wireless communication optionally including one or more microwave links, satellite communication, and other suitable elements that can transmit digital data.

An alert processor 108 can communicate with the depository server 104 and with other equipment via the distribution network 106. The alert processor 108 can function as a gateway and driving component for alerting services provided by a radio station. In some examples, the alert processor 108 can be a standalone server that resides at the station. In other examples, the alert processor 108 can reside in the cloud, and can include a front-end software component that runs on a station computer. By controlling the alert processor 108, the station can fully control the relevant alerts to broadcast. An initial configuration of the alert processor 108 can provide this control. The initial configuration can include the types of alert messages that the station wishes to distribute and the desired audience that the stations wishes to cover with the alert messages.

In some examples, the alert processor 108 can include one or more stand-alone computers disposed at a radio station, or at a remote location and linked to the radio station via a wired and/or wireless connection. In some examples, the alert processor 108 can alternatively be a virtual machine that runs in the cloud, with an execution on a remote server that is disposed away from the radio station and connected to the radio station via a wired and/or wireless connection. In this respect, the alert processor 108 can exist in hardware, software, or a combination of hardware and software.

In some examples, the alert processor 108 can be the sole controlling device of the alert system 100 of FIG. 1. In some examples, the alert processor 108 can cause the alert system 100 to operate (e.g., can initiate delivery of an alert). In some examples, the alert processor 108 can control sending of an alert message, control broadcasting of an alert message, control replacing an alert message, control updating an alert message, and/or control stopping a broadcast of an alert message.

In some examples, a particular configuration can determine how the alert processor 108 can receive the alert messages that are intended for the station. In one configuration, the alert processor 108 can scan all the known alert depository servers 104 and extract the relevant messages. In another configuration, the depository servers 104 can push relevant alerts to the alert processor 108.

The alert processor 108 can also receive alerts via equipment 110 dedicated to the existing Emergency Alert System (EAS). In some examples, the system of FIG. 1 can function as an add-on to the existing Emergency Alert System, and can operate without changing existing an analog system audio configuration, an existing HD radio system audio configuration, or a data configuration.

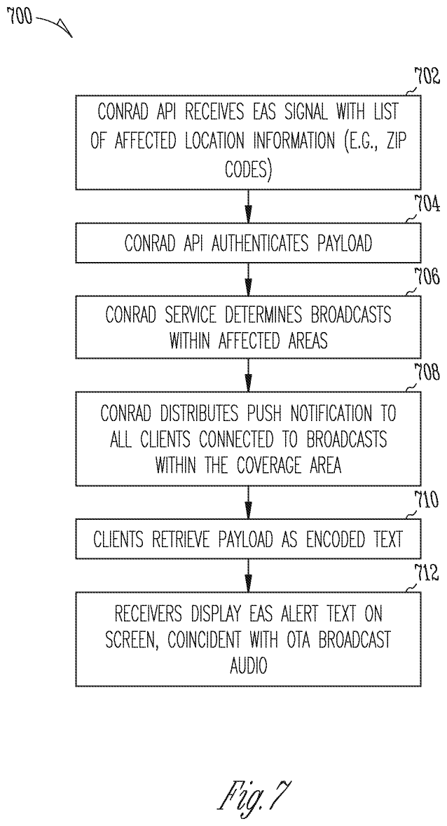

When the alert processor 108 receives an alert message, the alert processor 108 can log the alert message for further reference and monitoring. The alert message can be examined and validated (for example, by a person that works at the station) for integrity and suitability. When the suitability for broadcasting over-the-air is verified, the system 100 can extract a relevant textual and control data payload from the alert message, and convert the alert message to the proper hit stream format for broadcasting. FIGS. 8-15 and the accompanying text below discuss formatting in detail.

In some examples, the alert processor 108 can direct audio for additional channels, such as an HD2 channel and/or an HD3 channel, to an importer (not shown). In some examples, the alert processor 108 can direct a legacy EAS audio signal to an analog transmitter (not shown).

The alert system 100 can include an exporter 112. In general, an exporter 112 can accept Main Program Service (MPS) Audio Engineering Society (AES) audio and Program Services Data (PSD) from an automation server at the studio end. The exporter 112 can accept multiplexed SPS audio, SPS PSD and advanced application service data from an importer. In some examples, the exporter 112 can be visualized as a final multiplexer of MPS and all Advanced Application Service (AAS) data prior to developing the simplex via user datagram protocol (UDP) stream to the studio transmitter link (STL). In some examples, the exporter 112 can include the hardware and software necessary to generate the MPS and the Station Information Service (SIS). The MPS can provide the main program audio and PSD broadcast over the air to HD Radio receivers. The SIS can provide the station information (call sign, absolute time and position correlated to GPS).

The exporter 112 can execute the instructions provided by the alert processor 108 to provide over-the-air delivery of an alert. The exporter 112 can deliver the alert to a transmitter 114 for over-the-air delivery of the alert. The exporter 112 can interact with the alert processor 108 via internet protocol (IP), for conveying processed data and for managing the broadcasting of the alert. In some examples, the IP network connection between the alert processor 108 and the exporter 112 can operate at a relatively low bit rate. In some examples, the alert processor 108 and the exporter 112 can communicate the emergency alert message to each other via user datagram protocol (UDP). In some examples, the communication from the alert processor 108 to the exporter 112 can be via LDP on port 11000. In some examples, the communication from the exporter 112 to the alert processor 108 can be via UDP on port 9020. Other ports can also be used.

In some examples, the alert processor 108 can direct audio from a. primary channel, such as an HD1 channel, to the exporter 112.

In some examples, the exporter 112 can receive a command to broadcast a message. In some examples, the exporter 112 can receive a message from the alert processor 108. In some examples, the exporter 112 can start broadcasting the received message in a relatively short period of time, such as within three seconds. In some examples, the exporter 112 can broadcast the received message continuously. In some examples, the exporter 112 can receive a command from the alert processor 108 to stop broadcasting the received message.

It is worth summarizing the relationship between the alert processor 108 and the exporter 112. The alert processor 108 can receive alert content, in common alerting protocol (CAP) or in an EAS legacy format. The alert processor 108 can convert the alert content to an alert message. The alert processor 108 can send the alert message to the exporter 112 (via a radio station's IP network). The exporter 112 can broadcast an indication that an alert service is supported. The exporter 112 can broadcast the alert message.

In addition to over-the-air delivery of the alert, the system 100 can deliver the alert through an additional IP connection to connected broadcast receivers 102. The alert system 100 can be considered to be an add-on to the existing Emergency Alert System, in that it can add capability to the alerts (compared to over-the-air delivery), but can fully maintain operation of the existing Emergency Alert System. For example, the alert system 100 can provide HD radio receivers with a compressive description regarding the alert matter, which may not be provided by the existing Emergency Alert System. As another example, the alert system 100 can store an alert text and a matter description in a receiver, which can help deliver the alert to the listener without requiring the listener to listen to the receiver at a specified time, as required by the existing Emergency Alert System. As another example, a receiver using the alert system 100 can be placed in a stand-by mode, in which the receiver can scan for alerts in the background without being fully powered and without actively playing audio to the listener. When the receiver receives an alert, the receiver can power up and play the alert to the listener, which is not possible with the existing Emergency Alert System. This added capability can apply to receivers tuned to an HD radio station.

To deliver the alert to the receiver 102, the system 100 can employ IP communication in two stages. In a first stage, the system 100 can direct an alert from the alert processor 108, via a first connection 116, to the distribution network 106, and, via a second connection 118, to a connected radio (ConRad) server 120. In a second stage, the system 100 can direct the alert from the connected radio server 120, via the second connection 118, to the distribution network 106, and, via a third connection 122, to the receiver 102.

In some examples, the connected radio server 120 can include one or more stand-alone computers disposed at a radio station, or at a remote location and linked to the radio station via a wired and/or wireless connection. In some examples, the connected radio server 120 can alternatively be a virtual machine that runs in the cloud, with an execution on a remote server that is disposed away from the radio station and connected to the radio station via a wired and/or wireless connection. In this respect, the connected radio server 120 can exist in hardware, software, or a combination of hardware and software.

The first connection 116 and the second connection 118, together, can operate logically in a similar way to the interaction between the alert processor 108 and the exporter 112. In some examples, the first connection 116 and the second connection 118 can use the same communication rate and the same underlying command set that is used for communication 124 between the alert processor 108 and the exporter 112. In some examples, while the alert processor 108 and the exporter 112 can communicate with each other via user datagram protocol (UDP), the alert processor 108 and the connected radio server 120 can communicate with each other via a secure variant of transmission control protocol (TCP). As a result, the size of the packets can be slightly higher for TCP than for UDP, but the bandwidth required to transmit these packets can be negligible when compared to a bandwidth of the first connection 116 and the second connection 118. The connected radio server 120 can include specifications and an application programming interface that can accommodate communication between the alert processor 108 and the connected radio server 120. In some examples, the specifications and the programming interface can require that the alert processor 108 be a recognized entity by the connected radio server 120.

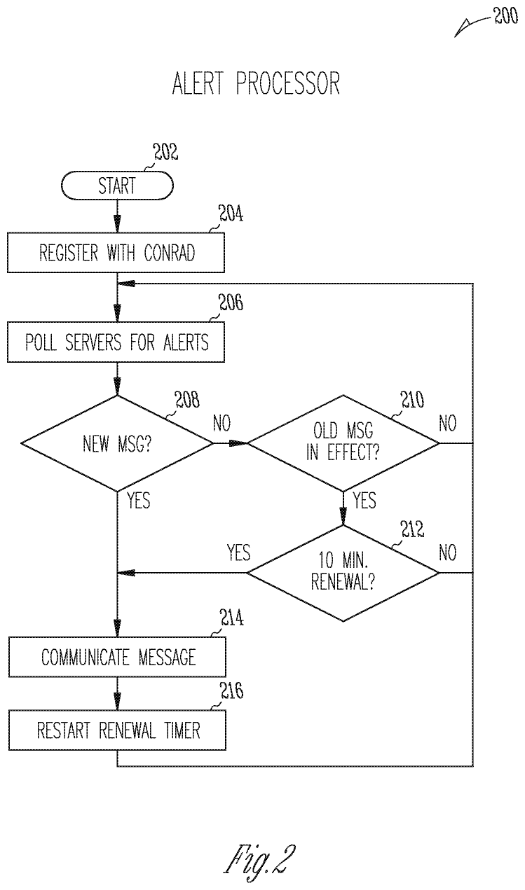

FIGS. 2-5 describe examples of how commands, control, and content can flow among the alert processor 108, the exporter 112, and the receiver 102 of FIG. 1. FIGS. 2-5 can provide a high-level overview of the interactions among these components and may omit additional operations performed at a lower level.

FIG. 2 shows an example of an emergency alert handling process 200 for an alert processor, such as 108 (FIG. 1), in accordance with some examples.

At operation 202, the alert processor can start the process 200.

At operation 204, the alert processor can register with the connected radio server, such as 120 (FIG. 1).

At operation 206, the alert processor can poll the depository servers (such as 104) for messages on the input side, while maintaining the status of one (potential) prior message.

At operation 208, the alert processor can determine if the depository servers include a new message.

If the depository servers include a new message, at operation 208, then the alert processor can distribute the new message by proceeding to operation 214.

If the depository servers do not include a new message, at operation 208, then the alert processor can determine, at operation 210, if the prior message is in effect (e.g., is still valid). If the prior message is no longer in effect, then the alert processor can return to operation 206. If the prior message is in effect, then the alert processor can set a renewal timer for a specified duration, such as ten minutes. The alert processor can determine, at operation 212, if the prior message will be in effect ten minutes into the future. If the prior message will no longer be in effect ten minutes into the future, the alert processor can return to operation 206. If the prior message will be in effect ten minutes into the future, the alert processor can renew the prior message by proceeding to operation 214.

At operation 214, the alert processor can send the new message or send the prior message to the connected radio server, such as 120 (FIG. 1). In some examples, the sending at operation 214 can require acknowledgement from the connected radio server. For these examples, the sending at operation 214 can differ from a sending operation in which the alert processor sends a message to the exporter, because sending to the exporter may not require acknowledgement from the exporter; sending to the exporter can therefore assume a successful delivery to the exporter.

At operation 216, the alert processor can restart a renewal timer. After a specified delay, such as ten seconds, thirty seconds, one minute, five minutes, or another suitable duration, the alert processor can return to operation 206.

If there is a communication failure at any point in process 200, the process can repeat the necessary step or steps once, or repeatedly every thirty seconds, or at another suitable time interval

Note that FIG. 2 shows an example of an emergency alert handling process 200 for an alert processor, which can be used in any radio station, even if such radio station does not broadcast in the HD Radio format. The process 200 can provide emergency alerts messages in HD Radio format to a connected receiver that is tuned to an analog-only station.

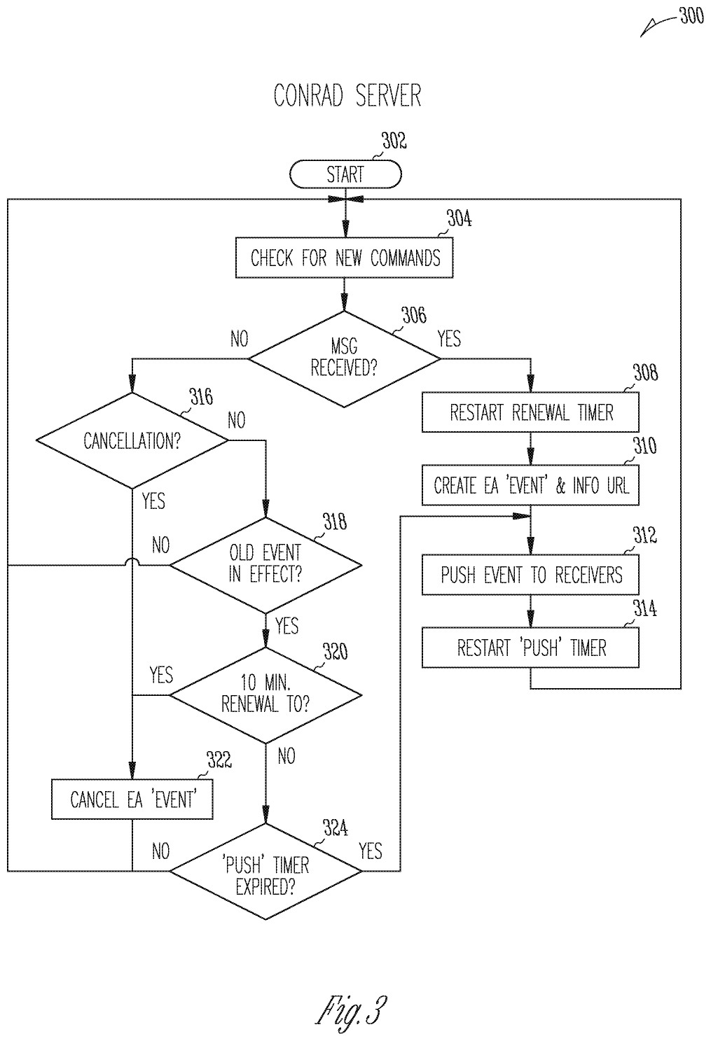

FIG. 3 shows an example of an emergency alert handling process 300 for a connected radio server, such as 120 (FIG. 1), in accordance with some examples.

At operation 302, the connected radio server can start the process 300.

At operation 304, the connected radio server can check for new commands from the alert processor, such as 108 (FIG. 1). Suitable commands can include registration, status query, sending a message and cancellation of the distribution of the current message. If the connected radio server, at operation 304, receives commands from the alert processor for registration, status, or cancellation, the connected radio server can respond in a straightforward manner, using the same responses as the exporter. If the connected radio server, at operation 304, receives a message distribution (or message broadcasting) command, the connected radio server can respond differently from the exporter, such as with operations 306 through 324, as discussed below.

At operation 306, the connected radio server can determine if the connected radio server has received a new message from the alert processor. If the connected radio server has not received a new message from the alert processor, at operation 306, then the connected radio server can proceed to operation 316, discussed below. If the connected radio server has received a new message from the alert processor, at operation 306, then the connected radio server can proceed to operation 308, discussed presently.

At operation 308, the connected radio server can restart a renewal timer.

At operation 310, the connected radio server can create an emergency alert event and a corresponding informational URL.

At operation 312, the connected radio server can push the emergency alert event and the corresponding informational URL to receivers, such as 102 (FIG. 1). Such pushing can occur over connections 118 and 122 (FIG. 1).

At operation 314, the connected radio server can restart a push timer, then proceed to operation 304.

At operation 316, when the connected radio server has not received a new message from the alert processor, at operation 306, then the connected radio server can determine if the connected radio server has received a cancellation instruction from the alert processor. If the connected radio server has received a cancellation instruction from the alert processor, at operation 316, then the connected radio server can proceed to operation 322, discussed below. If the connected radio server has not received a cancellation instruction from the alert processor, at operation 316, then the connected radio server can proceed to operation 318, discussed presently.

At operation 318, the connected radio server can determine if an old event is still in effect (e.g., is still valid). If the old event is no longer in effect, at operation 318, then the connected radio server can return to operation 304. If the old event is in effect, at operation 318, then the connected radio server can determine, at operation 320, if the old event has reached ten minutes (or another suitable time interval) without renewal by the alert processor, then renewal timeout has been reached. If, at operation 320, the connected radio server determines that the old event has not yet reached the renewal timeout, then the connected radio server can proceed to operation 324. If, at operation 320, the connected radio server determines that the old event has reached the renewal timeout (e.g. has not been renewed by the alert processor for ten minutes), then the connected radio server can proceed to operation 322.

At operation 322, the connected radio server can cancel the emergency alert event, then proceed to operation 304.

At operation 324, the connected radio server can determine if the push timer has expired. If the connected radio server determines, at operation 324, that the push timer has expired, then the connected radio server can proceed to operation 312. If the connected radio server determines, at operation 324, that the push timer has not expired, then the connected radio server can proceed to operation 304.

In some examples, because a radio station has resources to continuously broadcast an alert message as long as it is valid (e.g., did not time out), while a server can push events only periodically at a limited rate, a more frequent event management timing can be required, within a single renewal time period. Specifically, the renewal timing of the message validity, by message distribution command from the alert processor can remain up to but less than ten minutes. However, the server can push an event to the receivers every two minutes, or another suitable time interval that is significantly less than ten minutes. Such frequent pushing of the event can ensure that receivers that are tuning in to the station are being alerted within reasonably quickly. Such frequent pushing can also ensure that receivers that already maintain the alert and have missed a few event pushes do not time out on a valid (e.g., in-effect) alert.

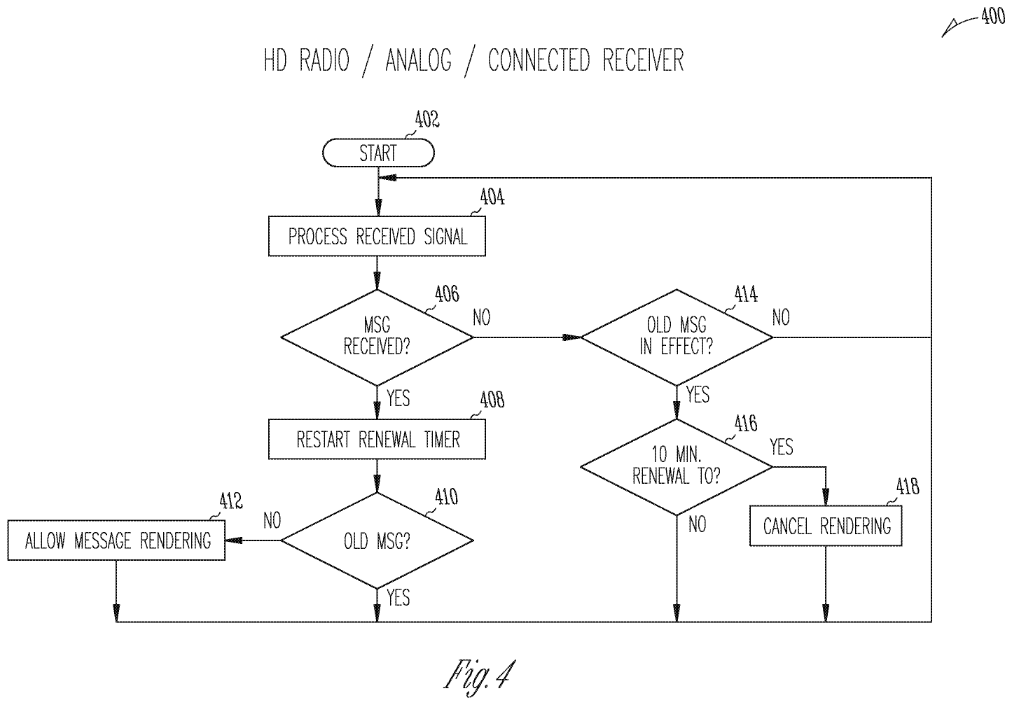

FIG. 4 shows an example of an emergency alert handling process 400 for an HD radio/analog/connected (e.g., streaming) receiver, such as 102 (FIG. 1), in accordance with some examples.

At operation 402, the connected receiver can start the process 400.

At operation 404, the connected receiver can process a received signal from the connected radio server and/or from the broadcasting station.

At operation 406, the connected receiver can determine if the received signal includes an alert message. If the connected receiver determines, at operation 406, that the received signal does not include an alert message, the connected receiver can proceed to operation 414, discussed below. if the connected receiver determines, at operation 406, that the received signal includes an alert message, the connected receiver can proceed to operation 408, discussed presently.

At operation 408, the connected receiver can restart a renewal timer.

At operation 410, the connected receiver can determine if the alert message received at operation 406 is an old message. If the connected receiver determines, at operation 410, that the alert message received at operation 406 is an old message, then the connected receiver can maintain an indication regarding the validity of the alert message, and proceed to operation 404. If the connected receiver determines, at operation 410, that the alert message received at operation 406 is not an old message, then the connected receiver can allow rendering of the message at operation 412, in addition to storing the message for browsing at a later time, and then proceed to operation 404.

At operation 414, at which the connected receiver has determined, at operation 406, that the received signal does not include an alert message, the connected receiver can determine if an old alert message is in effect. If the connected receiver determines, at operation 414, that the old alert message is not in effect, then the connected receiver can proceed to operation 404. If the connected receiver determines, at operation 414, that the old alert message is in effect, then the connected receiver can proceed to operation 416, discussed presently.

At operation 416, the connected receiver can determine if the old event has reached ten minutes (or another suitable time interval) with no renewal by the alert processor, then renewal timeout has been reached. If, at operation 416, the connected receiver determines that the old event will not be in effect ten minutes into the future, then the connected receiver can proceed to operation 404. If, at operation 416, the connected receiver determines that the old event has reached the renewal timeout, then the connected receiver can cancel rendering of the alert message at operation 418, and then proceed to operation 404.

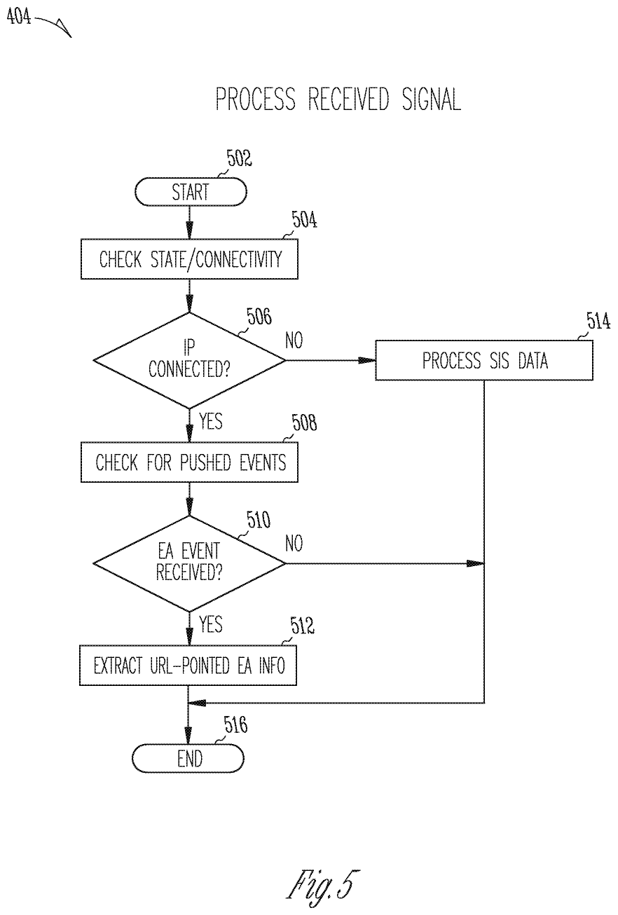

FIG. 5 shows an example of how the HD radio/analog/connected (e.g., streaming) receiver processes a received signal, such as at operation 404 (FIG. 4), in accordance with some examples.

At operation 502, the connected receiver can start the operation 404.

At operation 504, the connected receiver can check a state and/or connectivity of the connected receiver.

At operation 506, if the connected receiver has determined that the connected receive is not connected to an IP source, then the connected receiver can process the station information service (SIS) data from a received broadcast signal and end the operation 404 at operation 516. At operation 506, if the connected receiver has determined that the connected receiver is connected to an IP source, then the connected receiver can proceed to operation 508.

At operation 508, the connected receiver can check to determine if there are any events pushed by the alert processor.

At operation 510, if the connected receiver has determined that there are no events pushed by the alert processor, then the connected receiver can end the operation 404 at operation 516. At operation 510, if the connected receiver has determined that the alert processor has pushed an event and an emergency alert event has been received, then the connected receiver can proceed to operation 512.

At operation 512, the connected receiver can extract URL-pointed emergency alert information from the pushed event, and then end the operation 404 at operation 516.

FIG. 6 shows a flowchart of an example of a method 600 for operating an emergency alert broadcast distribution system for connected (e.g., streaming) services broadcast receivers, in accordance with some examples. The method 600 can be executed on the system 100 (FIG. 1), or on other suitable systems. The method 600 is but one example of a method for operating an emergency alert broadcast distribution system for connected services broadcast receivers; other suitable methods can also be used.

In some examples, the method 600 can require each broadcaster to implement the EAS system within the broadcast equipment, either as software or hardware. In some examples, the software or hardware can be developed for connectivity to the hybrid radio application programming interface (API), and configured with identification and authentication information specific to the broadcast for the hybrid radio API. Note that hybrid radio can refer to a radio environment that is served by broadcast and over internet protocol. In some examples, when an EAS alert is received, the hardware or software communicates with the hybrid radio API, transmitting the authentication information for the broadcast itself, in addition to authentication information for the EAS hardware or software, and the EAS message. In some examples, the hybrid radio API can then override any dynamic metadata present on the affected broadcast, can issue push notifications to the clients connected to the notification system for the affected broadcast, and can either distribute the EAS payload directly, or the client can then retrieve the payload with a second API request or link to a file for download. In some examples, the client can then receive the EAS alert message and can display it on a screen. In some examples, the method 600 can be used in addition to EAS audio broadcast, EAS message transmission via digital signal/sideband, or on analog-only broadcasts that have no other method to distribute textual alert messages. In the method 600, some functions of the alert processor 108 may be referred to as EAS unit.

At operation 602, an EAS unit can receive an EAS signal.

At operation 604, the EAS unit can compile information from the received EAS signal.

At operation 606, the EAS unit can use already-configured ID and authentication to transmit an EAS payload to a ConRad. API via a post using hypertext transfer protocol (HTTP). In some examples, the ConRad API can be located at the ConRad server. In some examples, the ConRad API can run on the ConRad server.

At operation 608, the ConRad API can receive and authenticate the payload.

At operation 610, the ConRad API can distribute a push notification to all connected clients for affected broadcasts.

At operation 612, clients can retrieve a payload as encoded text and control information.

At operation 614, receivers can display an EAS alert text on the receiver screens.

In some examples, the method 600 can include an operation 616, following operation 604, at which an EAS unit transmits information to broadcast equipment.

At operation 618, an EAS notification payload is distributed via digital broadcast.

At operation 620, client can retrieve the payload from the broadcast, then proceed to operation 614.

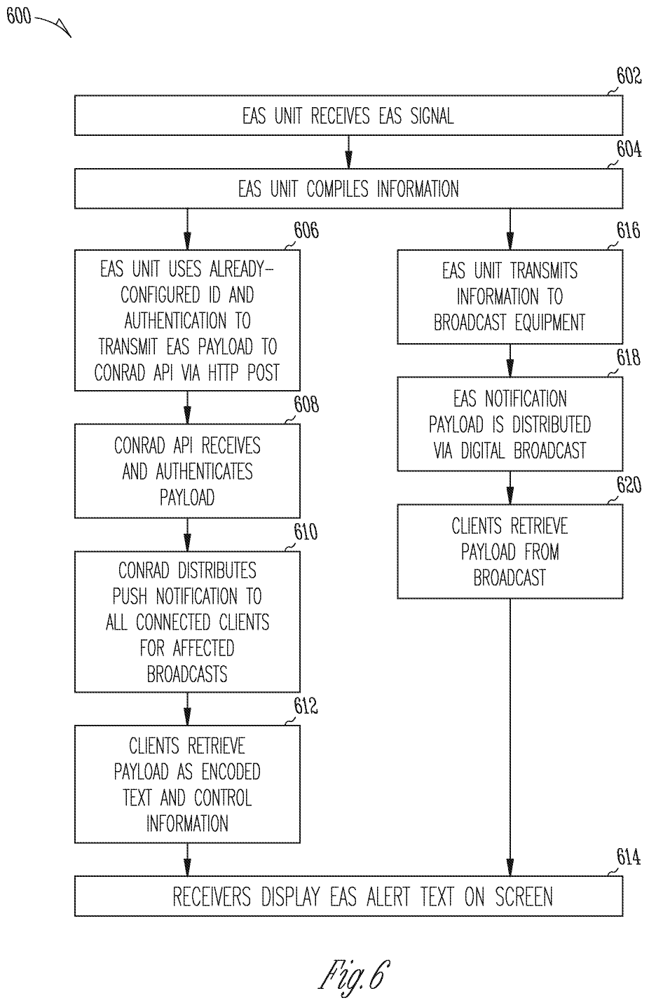

FIG. 7 shows a flowchart of another example of a method 700 for operating an emergency alert broadcast distribution system for connected (e.g., streaming) services broadcast receivers, in accordance with some examples. The method 700 can be executed on the system 100 (FIG. 1), or on other suitable systems. The method 700 is but one example of a method for operating an emergency alert broadcast distribution system for connected services broadcast receivers; other suitable methods can also be used.

In some examples, the method 700 may not require broadcast equipment, but rather can allow for the hybrid radio API itself to receive EAS alert messages with geographic coordinates, zip codes, or other suitable techniques for indicating location information, which describe the geographic areas affected by the alert message. In some examples, whether location information is available or whether location information is not available, the hybrid radio service can use the known coverage area of the broadcast station from which the alert message has been communicated by the alert processor 108 and issue push notification to clients within that area, that are connected to the notification system. In some examples, the hybrid radio service can then determine which broadcasts are within the affected area, and can overrides any dynamic metadata present on the affected broadcasts, can issue push notifications to the clients connected to the notification system for the affected broadcasts, and can either distribute the EAS payload directly, or the client can then retrieve the payload with a second API request or link to a file for download. In some examples, the client can then receive the EAS alert message and can display it on a screen. In some examples, the method 700 can be used in addition to EAS audio broadcast, EAS message transmission via digital signal/sideband, or on analog-only broadcasts that have no other method to distribute textual alert messages. In some examples, the method 700 may not require hardware or software or any configuration on the part of the broadcaster.

At operation 702, a ConRad API can receive an EAS signal, potentially with a list of affected areas.

At operation 704, the ConRad API can authenticate a payload.

At operation 706, the ConRad service can determine broadcasts within areas corresponding to the affected areas.

At operation 708, the ConRad API can distribute a push notification to all clients connected to broadcasts within the coverage area.

At operation 710, clients can retrieve a payload as encoded text and control information.

At operation 712, receivers can display an EAS alert text on the receiver screens.

FIG. 8 shows an example of a message depository container for use with a common altering protocol (CAP), in accordance with some examples. The container of FIG. 8 is but one example of a suitable container for an alert system; other suitable containers can also be used.

The alert messages generated by the alert system 100 of FIG. 1 can be in a common alerting protocol (CAP) format. CAP is a digital messaging format that is based on extensible markup language (XML).

In some examples, the container can include four groups of information and a relatively small number of essential fields for describing the alert. Some of these fields, in addition to several other optional fields, may not apply to the typical alert distribution methods to the consumer, such as broadcasting and Internet.

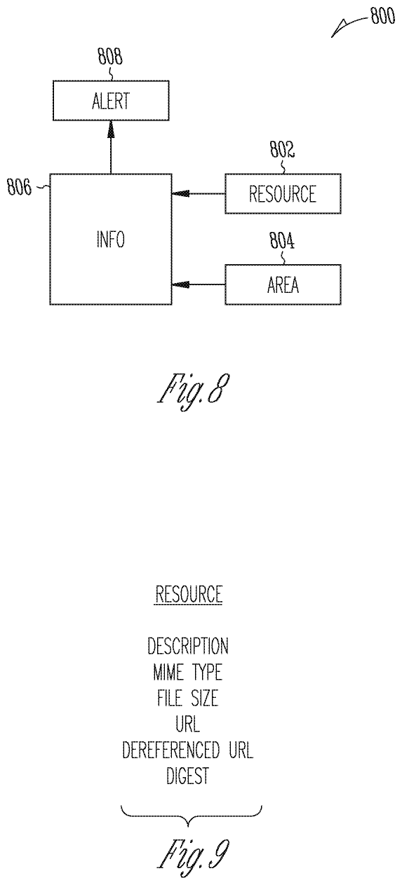

The four groups can include one or more resources 802, one or more areas 804, one or more info groups 806, and an alert 808. The one or more resources 802 and the one or more areas 804 contribute to the one or more info groups 806. The one or more info groups 806 contribute to the alert 808. Each of these groups has corresponding fields, shown in FIGS. 9-12 and discussed below.

FIG. 9 shows an example of fields found in each resource group of FIG. 8, in accordance with some examples.

In some examples, each resource group can include one or more mandatory fields, such as description and multi-purpose internet mail extension (MIME) type. In some examples, each resource group can include one or more optional fields, such as file size, uniform resource locator (URL), dereferenced URL, and digest.

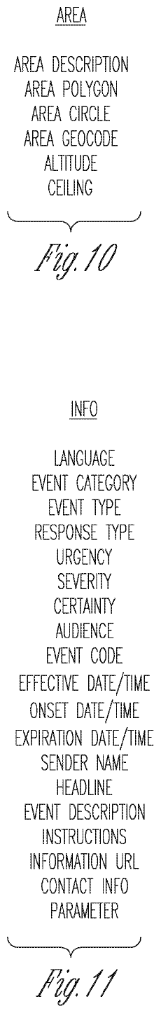

FIG. 10 shows an example of fields found in each area group of FIG. 8, in accordance with some examples.

In some examples, each area group can include one or more mandatory fields, such as area description. In some examples, each area group can include one or more optional fields, such as area polygon, area circle, area geocode, altitude, and ceiling. In some examples, one or more of the fields can include multiple instances of the field, such as area polygon, area circle, and area geocode.

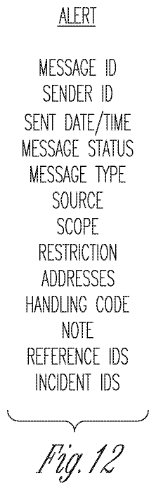

FIG. 11 shows an example of fields found in each info group of FIG. 8, in accordance with some examples.

In some examples, each info group can include one or more mandatory fields or parameters, such as event category, event type, urgency, severity, and certainty. In some examples, each info group can include one or more optional fields or parameters, such as response type, audience, event code, effective date/time, onset date/time, expiration date/time, sender name, headline, event description, instructions, information URL, contact info, and parameter. In some examples, one or more of the fields can include multiple instances of the field, such as event category, response type, event code, and parameter.

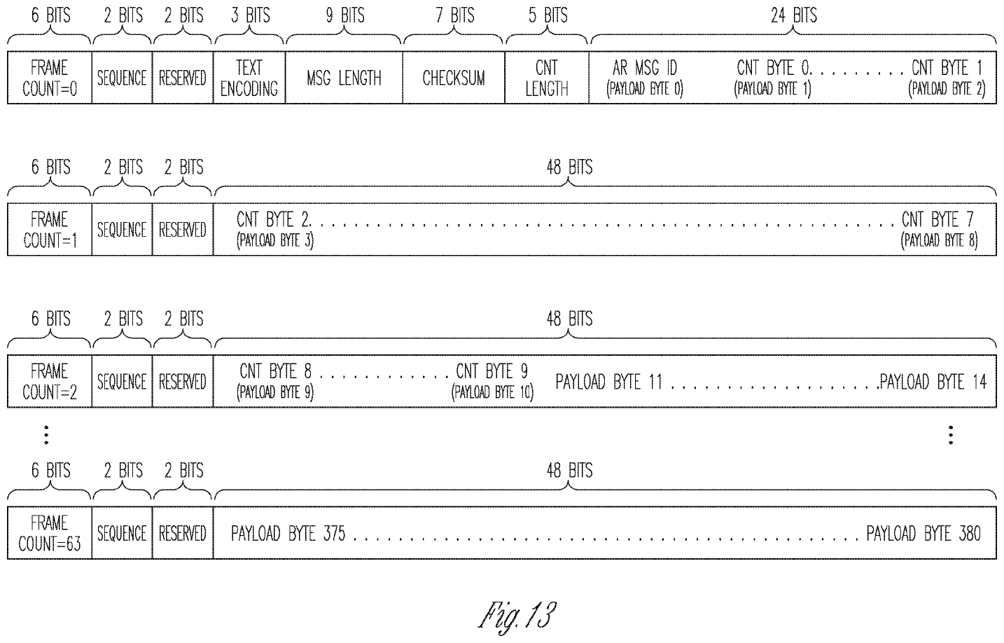

FIG. 12 shows an example of fields found in the alert group of FIG. 8, in accordance with some examples.

In some examples, each alert group can include one or more mandatory fields, such as message ID, sender ID, sent date/time, message status, message type, and scope. In some examples, each alert group can include one or more optional fields, such as source, restriction, addresses, handling code, note, reference IDs, and incident IDs. In some examples, one or more of the fields can include multiple instances of the field, such as handling code.

The examples of fields shown in FIGS. 9-12 are but mere examples, and other fields can also be used.

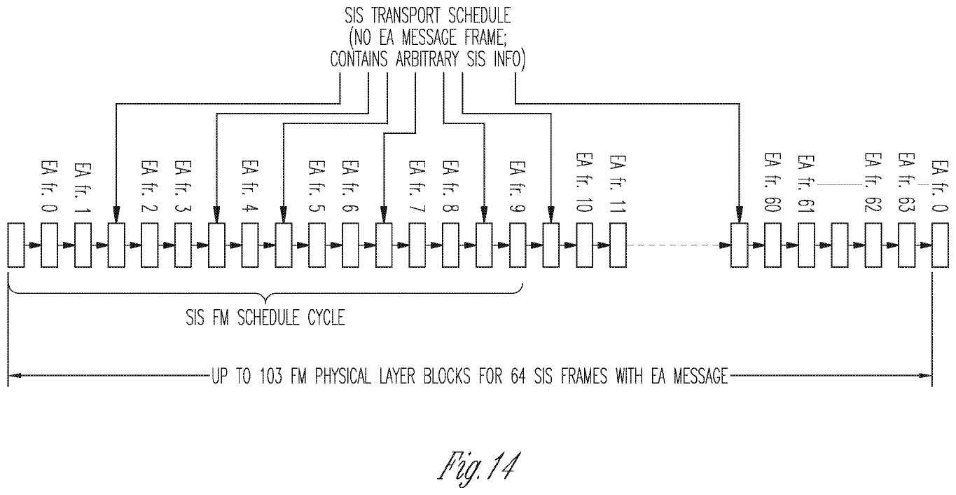

FIG. 13 shows an example of a payload structure for a processed message, in accordance with some examples. The payload structure of FIG. 13 is but one example of a payload structure; other suitable structures can also be used.

In the example of FIG. 13, the payload can be divided into segments called frames, for broadcast over a station information services (SIS)-dedicated channel. In the example of FIG. 13, a payload can span up to 64 frames; other numbers of frames can also be used.

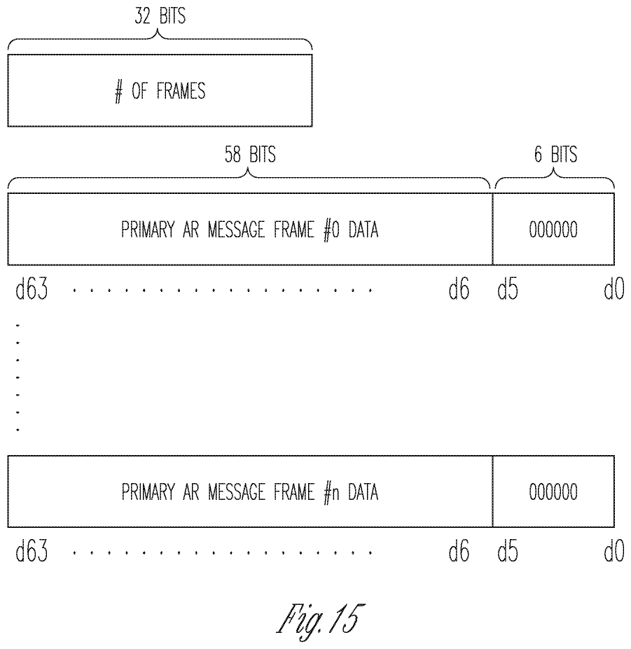

FIG. 14 shows an example of an emergency alert message frames distributed over a station information service (SIS) dedicated channel, in accordance with some examples.

In some examples, each emergency alert (EA) frame can be mapped to one SIS frame. In some examples, the entire emergency alert message can be transmitted cyclically, frame-by-frame. In some examples, the transmission may not be continuous. For examples, the transmission can be interleaved with other types of station information segments, such as call-sign, services, and so forth. The interleaving rate may be selected from a group of pre-determined rates in the configuration of the exporter. In a typical rate, as shown in FIG. 14, 64 EA frames can be transmitted over 103 SIS frames. Other suitable rates can also be used.

To broadcast an alert message, the message can be included in an integer number of frames. To communicate a payload over a station's network, from the alert processor to the exporter, each frame can be separately placed in an 8-byte segment.

FIG. 15 shows an example of an alert message encapsulation for internet protocol (IP) communication, in accordance with some examples. In some examples, the encapsulation, including the frame count, can reach up to 516 bytes, so that the network payload can be contained in a single network packet.

Delivering a payload in this manner can be performed on a relatively slow network connection. For example, the communications requirements between the alert processor and the exporter are far less than a typical IP network data rate. For example, a single payload delivery message (a single burst), including network-related encapsulation, can require fewer than 600 bytes, with a new payload (e.g., a new message) occurring potentially not faster than once every minute, and typically once every several minutes. In some examples, control messages can require 37 to approximately 100 bytes every several seconds (typically 120 seconds) when the IP link operates properly, and every 2 seconds when attempting to establish connection due to prior link failure (infrequent occurrence). These requirements are very forgiving, relative to some other IP applications.

In some examples, the network can reside in a relatively old studio-to-transmitter link, which may support only a unidirectional network connection. As a result, the alert processor and the exporter can initially communicate via user datagram protocol (UDP). In some examples, the alert processor can check for an acknowledgement from the exporter for each message. In some example, the alert processor can proceed without receiving an acknowledgement from the exporter for each message. For example, the alert processor can continue sending the sequence of control commands and message delivery commands to the exporter, without receiving an acknowledgement from the exporter.

There are benefits to using the system of FIG. 1, and the configurations shown in FIGS. 2-15. More specifically, there are differences associated with using a connected receiver that can receive streamed content via an IP streaming service, when compared with a receiver that can receive only over-the-air broadcast content. Two such differences are described presently.

A first difference can relate to processing of the received signal. In general, over-the-air broadcasting can use a continuous HD radio signal, and can also continuously broadcast an alert message while the alert message is in effect. In contrast, the connected radio server may not interact continuously with the connected receiver. Instead, the connected radio server and the connected receiver can interact intermittently, such as in response to a time-driven request, a query-driven request, or an event-driven request. This intermittent interaction may sometimes require an additional communication session to handle information that may not be transferred during an initial communication. The additional communication session can be pointed out by an event handed URL. To function with intermittent communication, the system can use a gating function for properly processing a received signal. FIG. 5 shows an example of a such a gating function that can allow the system to use intermittent communication.

A second difference can relate to snoozed messages. In general, for over-the-air-based receivers can lack the ability to snooze a message. Specifically, for over-the-air-based receivers, once a message is no longer valid, snooze does not apply, even if the same message is being transmitted at a later time. In contrast, because connected receivers use intermittent communication, the connected receivers can use special handling to address any potential time gaps in the communication. For examples, when a connected receiver receives a new message, the connected receiver can check a time stamp of the last snoozed message. The last snoozed message may no longer be valid. If the new message matches the last snoozed message, and the invalidation occurred up to two minutes earlier, then the connected receiver may prevent rendering of the message, and the message should be considered valid but snoozed.

In some examples, when the system of FIG. 1 is operational, the station's signal can indicate its support of the system, (even when no alert is in effect), so that receivers can inform the listeners of the station's support of the system.

In some examples, the message portion of an alert can support up to 374 text characters and target locations. The alert can originate via the Common Alerting Protocol (CAP) or via an existing protocol in the existing Emergency Alert System.

In some examples, weekly and/or monthly Emergency Alert System tests, which can be structured for analog signal broadcasts, can also pass through the alert system of FIG. 1. The alert system of FIG. 1 can optionally add text to enhance the alert.

In some examples, an alerting message content flow can include few processing instances, which cover the message from aggregation to over-the-air distribution. These instances can operate using separate equipment types from selected manufacturers, allowing mixing and replacing equipment with minimal configuration updates.

While this invention has been described as having example designs, the present invention can be further modified within the scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An audio delivery system, comprising:
an alert processor configured to parse alert content by:
receiving first data representing the alert content; and
converting the alert content to an alert message that includes alert text and parameters; and
a connected radio server coupled to the alert processor via internet protocol and configured to insert the alert content into a data stream by:
receiving second data representing the alert message from the alert processor via internet protocol;
receiving instructions from the alert processor via internet protocol to incorporate the alert message into the data stream, the data stream including an audio stream and the alert message; and
providing the data stream to a connected radio receiver via internet protocol.

2. The audio delivery system of claim 1, wherein the connected radio receiver is a connected HD radio receiver.

3. The audio delivery system of claim 1, wherein:
the second data includes regional data representing a geographic region pertaining to the alert message; and
the connected radio server is further configured to determine that the connected radio receiver lies within the geographic region.

4. The audio delivery system of claim 3, wherein:
the regional data includes one or more indicated areas affected by the alert content;
the connected radio server is further configured to compare a location of the connected radio receiver with the one or more indicated areas, and determine that the location of the connected radio receiver is positioned within the one or more indicated areas.

5. The audio delivery system of claim 1, further comprising:
an exporter configured to receive, from the alert processor, third data representing the alert message; and
a transmitter coupled to the exporter and configured to broadcast over-the-air an over-the-air audio stream that incorporates the alert message.

6. The audio delivery system of claim 5, wherein the exporter is configured to receive, from the alert processor, the third data via user datagram protocol (UDP).

7. The audio delivery system of claim 6, wherein the exporter is configured to direct data to the alert processor via a first port and receive data from the alert processor via a second port different from the first port.

8. The audio delivery system of claim 1, wherein the connected radio server is configured to receive, from the alert processor, the second data via a secure variant of transmission control protocol (TCP).

9. The audio delivery system of claim 8, wherein the connected radio server is configured to direct data to the alert processor via a first port and receive data from the alert processor via a second port different from the first port.

10. The audio delivery system of claim 1, wherein:
the alert processor is further configured to receive the first data from at least one depository server;
the at least one depository server is positioned remote to the alert processor and remote to the connected radio server; and
the at least one depository server is connected via internet protocol to the alert processor.

11. The audio delivery system of claim 1, wherein the connected radio receiver is further configured to:
repeatedly check, at a specified time interval, the alert-augmented data. stream to determine if the alert processor has issued an alert message;
determine that the alert processor has issued an alert message; and
extract, from the alert-augmented data stream, a uniform resource locator (URL) corresponding to the alert message.

12. A method for operating an audio delivery system, the method comprising:
receiving, with an alert processor, first data representing alert content;
converting, with the alert processor, the alert content to an alert message that includes alert text and parameters;
receiving, with a connected radio server coupled to the alert processor via internet protocol, second data representing the alert message from the alert processor via internet protocol;
receiving, with the connected radio server, instructions from the alert processor via internet protocol to incorporate the alert message into the data stream, the data stream including an audio stream and the alert message; and
providing, with the connected radio server, the data stream to a connected radio receiver via internet protocol.

13. The method of claim 12, wherein the connected radio receiver is a connected HD radio receiver.

14. The method of claim 12, wherein:
the second data includes regional data representing a geographic region pertaining to the alert message;
the connected radio server is further configured to determine that the connected radio receiver lies within the geographic region;
the regional data includes one or more indicated areas affected by the alert content;
the connected radio server is further configured to compare a location of the connected radio receiver with the one or more indicated areas and determine that the location of the connected radio receiver is positioned within the one or more indicated areas.

15. The method of claim 12, further comprising:
receiving, from the alert processor, with an exporter via user datagram protocol (UDP), third data representing the alert message; and
broadcasting over-the-air, with a transmitter coupled to the exporter, an over-the-air audio stream that incorporates the alert audio.

16. The method of claim 15, wherein the exporter directs data to the alert processor via a first port and receives data from the alert processor via a second port different from the first port.

17. The method of claim 12, wherein the connected radio server is configured to:
receive, from the alert processor, the second data via a secure variant of transmission control protocol (TCP); and
direct data to the alert processor via a first port and receive data from the alert processor via a second port different from the first port.

18. The method of claim 12, wherein:
the alert processor receives the first data from at least one depository server;
the at least one depository server is positioned remote to the alert processor and remote to the connected radio server; and
the at least one depository server is connected via internet protocol to the alert processor.

19. An audio delivery system, comprising:
an alert processor configured to parse alert content by:
receiving first data representing the alert content; and
converting the alert content to an alert message that includes alert text and parameters; and
a connected radio server coupled to the alert processor via internet protocol and configured to insert the alert content into a data stream by:
receiving, via a secure variant of transmission control protocol (TCP), second data representing the alert message from the alert processor via internet protocol;
receiving instructions from the alert processor via internet protocol to incorporate the alert message into the data stream, the data stream including an audio stream and the alert message; and
providing the data stream to a connected radio receiver via internet protocol;
an exporter configured to receive, from the alert processor, via user datagram protocol (UDP), third data representing the alert message; and
a transmitter coupled to the exporter and configured to broadcast over-the-air an over-the-air audio stream that incorporates the alert message.

20. The audio delivery system of claim 19, wherein the connected radio receiver is a connected HD radio receiver.
